(19) United States
(12) Patent Application Publication
(10) Pub. No.: US 2006/0133678 A1
(43) Pub. Date: Jun. 22, 2006

(54) Data transfer system

(75) Inventor: Kenji Yokota, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/295,637

(22) Filed: Dec. 7, 2005

(30) Foreign Application Priority Data
Dec. 22, 2004 (JP) 2004-371698

(51) Int. Cl. G06K 9/36; G06K 15/00

(52) U.S. Cl. 382/239; 358/1.17

(57) ABSTRACT

There is provided a data transfer system capable of performing reliable data transfer while suppressing increases in costs. The data transfer system includes a data compressing apparatus and a data decompressing apparatus. The data compressing apparatus includes: a CPU which performs a compression process for applying compression to uncompressed electronic data to obtain compressed electronic data and performs a determination process for determining whether or not the compression process achieves predetermined targeted compression; and an output section which, only if the compression process achieves the predetermined targeted compression, outputs the compressed electronic data, and otherwise outputs uncompressed electronic data. The data decompressing apparatus includes a decompressing section which performs a decompression process only if electronic data received from the data compressing apparatus is compressed electronic data.

### BACKGROUND OF THE INVENTION

1. Field of the Invention

The present invention relates to a data transfer system including a data compression apparatus and a data decompression apparatus. The data compression apparatus compresses electronic data and outputs the compressed data. The data decompression apparatus decompresses electronic data outputted from the data compression apparatus and provides it to a predetermined destination.

2. Description of the Related Art

The techniques of applying compression to image data have been widely used in order to save storage space and reduce the amount of data transmission.

For example, a technique is known in which image data is separated into continuous tone (CT) data and data such as text and line work (LW), and compression suitable for each data is applied to each type of the data (see for example Japanese Patent Laid-Open No. 6-113145).

Another technique is known in which, when compression is applied to blocks having a predetermined size on a block by block basis, the compression ratio for each block is adjusted so that each block after compression has always a constant size (see for example U.S. Pat. No. 6,330,363B1), for convenience in processing after the compression.

One data transfer system to which a data compression technique is applied will be described below.

FIG. 1 shows an example of a data transfer system to which a data compression technique is applied and which transfers image data to a printer.

Shown in FIG. 1 is a data transfer system 10 including a Digital Front End Processor (DFE) 100 and a Back End Processor (BEP) 200. Also shown is a printer 20 to which the data transfer system 10 transfers image data. The DFE 100 and the BEP 200 are interconnected thorough a general-purpose interface cable 150 conforming to SCSI, and the BEP 200 is connected with the printer 20 through a dedicated interface cable 260.

In the DFE 100, raster image processing (RIP) is applied to image data described in a page description language to generate bitmap data. A compression process is applied to the bitmap data to generate compressed data in the DFE 100. The compressed data is transmitted from the DFE 100 to the BEP 200 through the general-purpose interface cable 150.

In the BEP 200, the compressed data is decompressed to generate bitmap data substantially equivalent to the uncompressed bitmap data. The bitmap data generated is provided to the printer 20, where an image based on the bitmap data is outputted.

A configuration of the BEP 200 will be described below.

FIG. 2 is a block diagram of the BEP shown in FIG. 1.

As shown in FIG. 2, the BEP 200 includes a receiving section 210, an image buffer 220, a decompressing section 230, a line buffer 240, and a printer output section 250.

The receiving section 210 receives compressed data transferred from the DFE 100 using SCSI. The image buffer 220 which temporarily holds several pages of compressed data is provided between the receiving section 210 and the decompressing section 230 so that the decompressing section 230 can take in and decompress the compressed data with a predetermined timing. The printer output section 250 outputs bitmap data generated by decompression applied by the decompressing section 230, which is substantially equivalent to the uncompressed bitmap data, to the printer 20 at an output rate commensurate with the processing rate of the printer 20. Because an image is outputted on the printer 20 with a predetermined timing, the printer output section 250 must provide bitmap data sequentially generated by decompression by the decompressing section 230 to the printer 20 with that predetermined timing. Therefore, the line buffer 240 which temporarily holds a predetermined unit of bitmap data is provided between the decompressing section 230 and the printer output section 250.

When bitmap data is read out by the printer output section 250 from the line buffer 240, the decompressing section 230 takes in compressed data from the image buffer 220 with a predetermined timing, decompresses it, and provides the decompressed data to the line buffer 240 in order to fill the line buffer 240. Consequently, the decompressing section 230 provides the decompressed bitmap data to the line buffer 240 at the same output rate as that of the printer output section 250. On average, the decompressing section 230 takes in compressed data at a rate equal to that output rate multiplied by a compression ratio. When the decompressing section 230 reads out compressed data from the image buffer 220, the receiving section 210 receives compressed data from the DFE 100 in order to fill the image buffer 220. That is, the receiving section 210 receives compressed data from the DFE 100 at the same average rate as the average rate at which the decompressing section 230 takes in compressed data.

There is an upper limit to the average rate at which the decompressing section 230 takes in compressed data (hereinafter referred to as the intake rate) because of the performance capabilities of the decompressing section 230. Also, the average rate at which the receiving section 210 receives compressed data (hereinafter referred to as the receiving rate) is also limited according to SCSI.

The compression ratio with which the DFE 100 compresses bitmap data varies depending on the image represented by image data to be compressed. Data compressed with a high compression ratio result in a large volume of bitmap data generated by decompression by the decompressing section 230 and consequently both of the intake rate of the decompressing section 230 and the receiving rate of the receiving section 210 decrease. Therefore, the decompressing section 230 and the receiving section 210 can perform processing at a rate well within the upper limit rates.

An example will be considered in which data compressed with a high compression ratio of 1/10 is sent to the BEP 200 and bitmap data generated by decompressing the data is outputted to a printer 20 that outputs an image at a processing rate of 300 Mbytes/s. It is assumed here that the upper limit rate at which the decompressing section 230 can take in compressed data is 100 Mbytes/s and the upper limit rate at which the receiving section 210 can receive compressed data is 80 Mbytes/s.

The rate at which the printer output section 250 reads out bitmap data from the line buffer 240 and outputs it to the printer 20, namely the output rate is equal to the processing rate of the printer 20, which in this case is 300 Mbytes/s. The average rate at which the decompressing section 230 provides decompressed bitmap data to the line buffer 240 is the same as the output rate of the printer output section 250, that is, 300 Mbytes/s. Consequently, the intake rate of the decompressing section 230 is the output rate multiplied by the compression ratio, that is, 30 Mbytes/s. The receiving rate of the receiving section 210 is the same as this intake rate, that is, 30 Mbytes/s. Accordingly, both of the decompressing section 230 and the receiving section 210 can perform processing at a rate well within the upper limit rates.

On the other hand, data compressed with a low compression ratio results in a small volume of bitmap data generated by decompression by the decompressing section 230. Accordingly, the decompressing section 230 takes in more compression data in order to sufficiently fill the line buffer 240 and consequently the intake rate of the decompressing section 230 increases. However, if the compression ratio is too low, the decompressing section 230 cannot sufficiently fill the line buffer 240 even if the intake rate of the decompressing section 230 reaches its upper limit. As a result, a problem occurs on the printer 20, such as discontinuity in an image.

An example will be considered in which data compressed with a low compression ratio of ½ is sent to the BEP 200 and bitmap data generated by decompression is outputted to a printer 20 that outputs images at a processing rate of 300 Mbytes/s. As in the example given above, it is assumed that the upper limit to the intake rate of the decompressing section 230 is 100 Mbytes/s and the upper limit value of the receiving rate of the receiving section is 80 Mbytes/s.

Because the buffer 220 has a sufficiently large capacity, the decompressing section 230 can take in and decompress compressed data at the upper limit intake rate (100 Mbytes/s), which exceeds the upper limit receiving rate (80 Mbytes/s) of the receiving section 210, at the maximum. However, even if the decompressing section 230 takes in and decompresses compressed data at the upper limit rate (100 Mbytes/s), the decompressing section 230 outputs bitmap data to the line buffer 240 at a low rate of 200 Mbytes/s. Consequently, the printer output section 250 can output bitmap data at a rate of only 200 Mbytes/s and thus cannot keep pace with the processing rate (300 Mbytes/s) of the printer 20.

One method to avoid this problem may be to provide a decompressing section that has a sufficiently high upper-limit intake rate.

Another method may be to provide a buffer with a large capacity, in place of the line buffer 240. If the printer 20 outputs images page by page, a large-capacity buffer can temporarily hold one or more pages of bitmap data required for ensuring the page-by-page image output if the printer 20 outputs images page by page and thereby the printer output section 250 can read out bitmap data from the buffer and output it to the printer 20 at a required output rate.

However, these methods require a special component such as a high-performance decoding section or a large-capacity line buffer, which leads to increased manufacturing costs.

### SUMMARY OF THE INVENTION

The present invention has been made in view of the above circumstances and provides a data transfer system capable of reliably transferring data while suppressing increases in costs.

A transfer system according to the present invention includes:
a data compressing apparatus and a data decompressing apparatus, the data compressing apparatus includes:
   a data compressing section which applies compression to uncompressed electronic data to obtain compressed electronic data; and
   a data output section, which, if the compression achieves predetermined targeted compression, outputs compressed electronic data obtained by the data compressing section, and if the compression does not achieve the targeted compression, outputs uncompressed electronic data which is not subjected to the compression,
the data decompressing apparatus including:
   a data receiving section which receives electronic data from the data compressing apparatus; and
      a transferring section which, if the electronic data received at the receiving section is compressed electronic data, decompresses the electronic data and transfers the decompressed data to a predetermined destination, and if the electronic data received at the receiving section is uncompressed electronic data, transfers the electronic data to the destination as is.

When electronic data cannot be compressed to a targeted degree by compression in the data compressing apparatus, the data is likely not to be transferred to the destination at a required rate because it would take long time to decompress the electronic data if it were constrainedly compressed and sent to the data decompressing apparatus. However, according to the data transfer system of the present invention, uncompressed electronic data which does not require decompression is provided to the data decompressing apparatus. Consequently, in the transferring section in the data decompressing apparatus, electronic data decompressed to a low extent that can be an obstacle in transfer to the destination is diverted around decompression and is transferred to the destination without delay. The data transfer system according to the present invention does not require costly components that increase manufacturing costs, such as a high-performance component capable of performing fast decompression, as the component performing decompression in the transferring section. Therefore, increases in manufacturing costs are suppressed. That is, the data transfer system according to the present invention is capable of performing reliable transmission while suppressing increases in costs.

In a preferred embodiment of the data transfer system, the data compressing section sequentially applies the compression to each piece of a set of uncompressed electronic data; and the data output section sequentially checks the result of compression applied by the data compression section and, if the targeted compression is achieved, outputs the compressed electronic data obtained from the set of the uncompressed electronic data in the data compression section, and if a result that does not achieve the targeted compression is provided, causes the data compression section to stop decompression and outputs the set of uncompressed electronic data.

Electronic data can contain a data portion that is compressed to a low extent. According to the data transfer system in the preferred embodiment, the result of compression applied by the data compressing section of the data compressing apparatus is sequentially checked. Therefore, if electronic data to be compressed contains a data portion that is compressed to a lower extent, the lowered degree of compression of the data portion is identified without fail. Consequently, more reliable data transfer can be performed.

As has been described, according to the present invention, a data transfer system capable of performing reliable data transfer can be provided while suppressing increases in costs.

### BRIEF DESCRIPTION OF THE DRAWINGS

FIG. 1 shows an example of a data transfer system which transfers image data to a printer and to which a data compression technique is applied;

FIG. 2 is a block diagram of the BEP shown in FIG. 1;

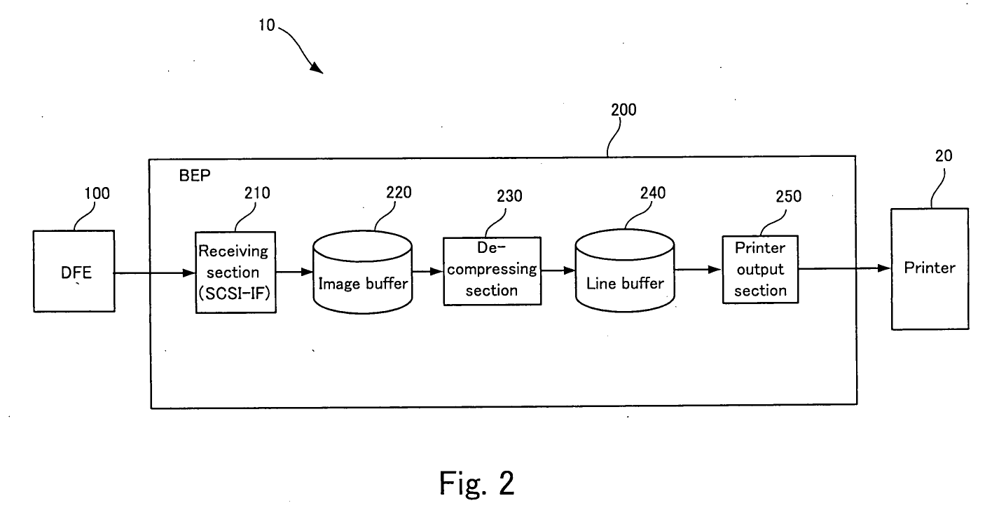

FIG. 3 shows an example of a data transfer system according to the present invention; and

FIG. 4 is a block diagram showing the DFE and BEP shown in FIG. 3.

### DETAILED DESCRIPTION OF THE INVENTION

An embodiment of the present invention will be described with reference to the accompanying drawings.

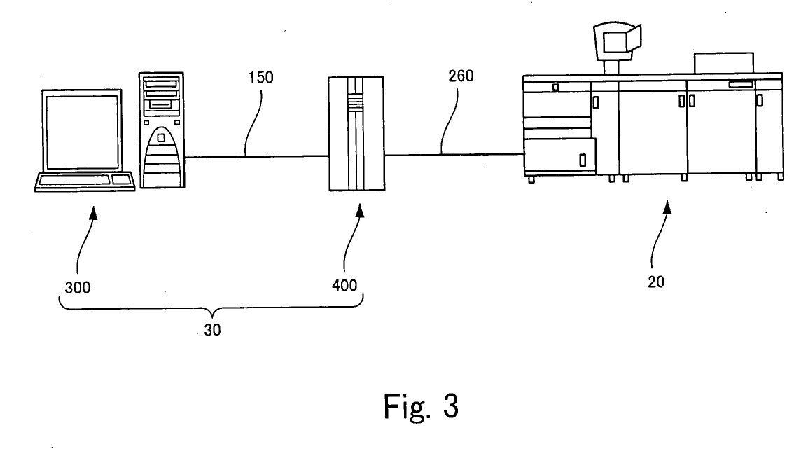

FIG. 3 shows an example of a data transfer system according to the present invention.

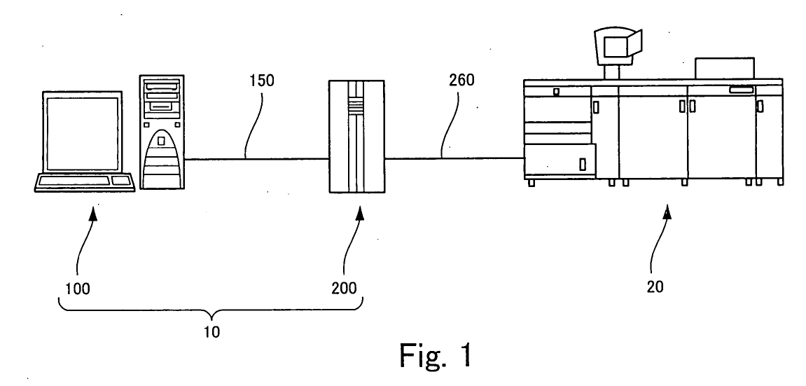

FIG. 3 also shows components such as a printer equivalent which are to those shown in FIG. 1. The components equivalent to those in FIG. 1 are therefore labeled with the same reference numerals and redundant description of which will be omitted.

Shown in FIG. 3 is a data transfer system 30 including a DFE 300 and a BEP 400, as well as a printer 20 to which bitmap data is transferred, a general-purpose interface cable 150 conforming to SCSI, and a dedicated interface cable 260, which are also given in FIG. 1. The DFE 300 and the BEP 400 represent an example of a data compressing apparatus and a data decompressing apparatus, respectively, in the present invention. The printer 20 represents an example of a destination in the present invention.

The DFE 300 is basically responsible for applying RIP to image data representing an image consisting of a two-dimensional array of multiple pixels to generate bitmap data and compressing the bitmap data block by block that corresponds to 8 rows of pixels, with each block being equivalent to an array of 8 rows of pixels, then providing the compressed bitmap data page by page to the BEP 400. If a page of bitmap data contains a block that has compressed with a compression ratio lower than a targeted compression ratio, the DFE 300 provides uncompressed bitmap data corresponding to the page to the BEP 400.

The BEP 400 is basically responsible for decompressing compressed bitmap data provided from the DFE 300 to practically restore the original bitmap data and transferring it to the printer 20. If uncompressed bitmap data is provided from the DFE 300 as mentioned above, then the BEP 400 transfers the bitmap data as is to the printer 20.

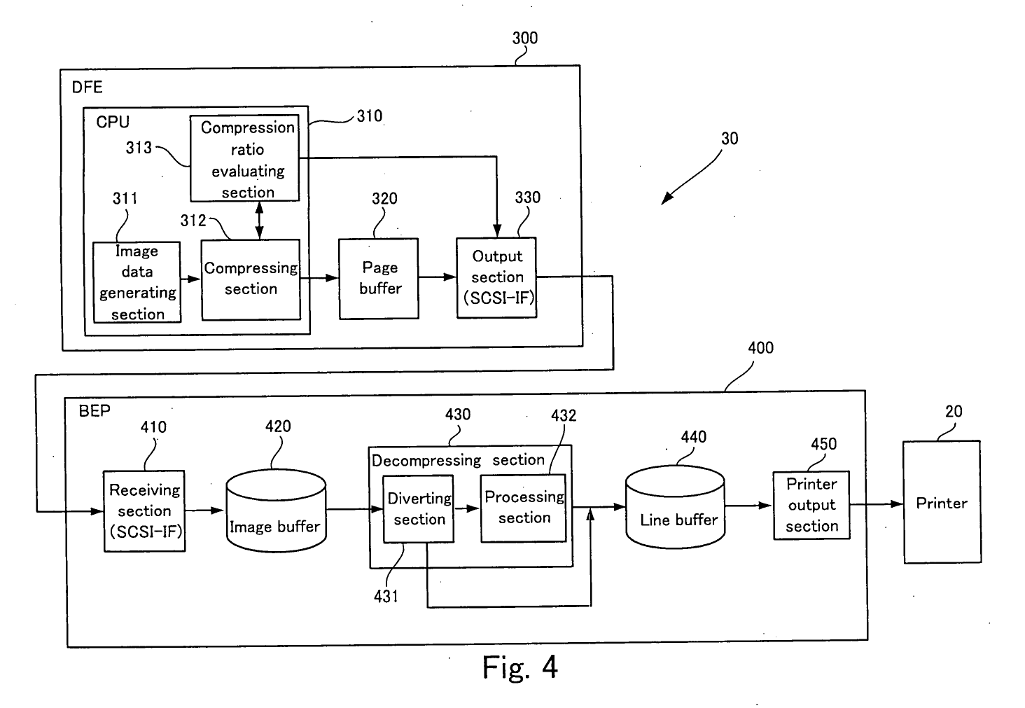

FIG. 4 is a block diagram showing the DFE and BEP shown in FIG. 3.

As shown in FIG. 4, the DFE 300 includes a CPU 310, a page buffer 320, and an output section 330. The CPU 310 represents an example of a data compressing section in the present invention and the combination of the CPU 310 and the output section 330 represents an example of a data output section in the present invention.

Also as shown in FIG. 4, the BEP 400 includes a receiving section 410, an image buffer 420, a decompressing section 430, a line buffer 440, and a printer output section 450. The receiving section 410 represents an example of receiving section in the present invention and the combination of the decompressing section 430 and the printer output section 450 represents an example of a transferring section in the present invention.

While the CPU 310 of the DFE 300 controls operation of the entire DFE 300, only part of operation that directly relates to the present invention will be described herein.

The CPU 310 functions as an image data generating section 311, a compressing section 312, and a compression ratio determining section 313, which are shown in FIG. 4 and will be described below, according to a control program, not shown.

The CPU 310 functioning as the image data generating section 311 applies RIP to image data representing an image consisting of a two-dimensional array of multiple pixels in one or more pages to generate bitmap data.

The CPU 310 functioning as the compressing section 312 applies compression to the generated bitmap data page by page. During the compression, one page of bitmap data is compressed block by block, each being equivalent to an array of 8 rows of pixels, and compressed data is sequentially generated on a block-by-block basis.

The CPU 310 functioning as the compression ratio determining section 313 computes the compression ratio of sequentially generated compression data to the uncompressed bitmap data and determines whether a targeted compression ratio is attained or not each time a block of compressed data is generated. In the present embodiment, the targeted compression ratio is set to a value according to the rate at which the printer output section 450 of the BEP 400 outputs data to the printer 20 and the rate at which the decompression section 430 of the BEP 400 takes in compressed data. The targeted compression ratio will be described later after the description of the decompressing section 430 and the printer output section 450 of the BEP 400.

As long as a result is obtained indicating that the targeted compression ratio is attained in the determination performed sequentially, both compressed data generated and its corresponding uncompressed bitmap are provided from the CPU 310 to the page buffer 320 block by block. On the other hand, if once it is determined that the targeted compression ratio is not attained, then the compression of the subsequent blocks is suspended and uncompressed bitmap data corresponding to the block at which that determination has been made and the subsequent blocks is provided from the CPU 310 to the page buffer 320.

If a result indicating that targeted compression ratio is attained has been obtained for all blocks of one page of bitmap data, the CPU 310 directs, after the completion of the output of the page of compressed data to the page buffer 320, the output section 330 to read out the page of compressed data from the page buffer 320 and output it to the BEP 400. On the other hand, if once a result is obtained indicating that the targeted compression ratio is not attained during compression of one page of bitmap data, then the CPU 310 directs, after the completion of the output of the page of bitmap data to the page buffer 320, the output section 330 to read out one page of bitmap data from the page buffer 320 and to output it.

The page buffer 320 has a capacity for holding one page of compressed data and one page of bitmap data provided from the CPU 310.

When the CPU 310 directs the output section 330 to output compressed data, the output section 330 starts to read out the compressed data from the page buffer 320 and to output the compressed data to the BEP 400 in conformity to SCSI. When the CPU 310 directs the output section 330 to output bitmap data, the output section 330 starts to read out the bitmap data from the page buffer 320 and to output the bitmap data to the BEP 400.

The receiving section 410 of the BEP 400 receives one page of compressed data or one page of bitmap data sent from the output section 330 of the DFE 300 in conformity to SCSI. The receiving section 410 provides the compressed data or bitmap data to the image buffer 420.

The image buffer 420 stores several pages of compressed data or bitmap data received at the receiving section 410.

The decompressing section 430, which has a diverting section 431 and a processing section 432, is responsible for decompressing compressed data stored in the image buffer 420 and providing the decompressed data to the line buffer 440, and bitmap data stored in the image buffer 420 to the line buffer 440 as is.

The diverting section 431 of the decompressing section 430 makes determination as to whether data stored in the image buffer 420 is compressed data or bitmap data. If the stored data is compressed data, the diverting section 431 reads out the compressed data from the image buffer 420 and provides it to the processing section 432 at the same rate as the intake rate of the processing section 432. On the other hand, if the data stored in the image buffer 420 is bitmap data, then the diverting section 431 reads out the bitmap data from the image buffer 420 and provides it to the line buffer 440 at the same rate as the output rate of the printer output section 450.

The processing section 432 of the decompressing section 430 takes in compressed data provided from the diverting section 431, decompresses it block by block to generate bitmap data which is practically equivalent to the original bitmap data of the compressed data, and provides it to the line buffer 440. Because the processing section 432 provides the decompressed bitmap data to the line buffer 440 at the same rate as the output rate of the printer output section 450, the processing section 432 takes in the compression data to be decompressed at an intake rate equal to the output rate multiplied by the compression ratio of the compressed data.

The line buffer 440 has a capacity for holding an amount of data large enough for the printer output section 450 to read out bitmap data from the line buffer 440 and to output the data at an output rate equal to the processing rate of the printer 20. Stored in the line buffer 440 is bitmap data sent from the diverting section 431 of the decompression section 430 or bitmap data generated by decompression by the processing section 432 of the decompressing section 430.

The printer output section 450 reads bitmap data from the line buffer 440 and outputs the data to the printer 20 at an output rate equal to the processing rate of the printer 20.

In order for the printer output section 450 to output bitmap data to the printer 20 without delay, the line buffer 440 must be filled with an amount of bitmap data that has been read out by the printer output section 450. The printer 20 outputs images page by page. Accordingly, while the printer 20 is outputting the image of each page, the printer 20 must continue to be supplied with bitmap data uninterruptedly. Furthermore, the line buffer 440 must continue to be supplied with bitmap data at the same rate as the output rate of the printer output section 450 until the supply of one page of bitmap data is completed.

If uncompressed bitmap data is to be stored in the line buffer 440, the diverting section 431 provides the bitmap data to the line buffer 440 at a rate equal to the output rate of the printer output section 450. That is, bitmap data is stored in the line buffer 440 at the required rate.

On the other hand, if bitmap data generated by decompression by the processing section 432 of the decompressing section 430 is to be stored in the line buffer 440 at the same rate as the output rate of the printer output section 450, the processing section 432 takes in compressed data at a rate equal to that output rate multiplied by the compression ratio of the compressed data, decompresses the data, and provides the decompressed bitmap data to the line buffer 440. There is an upper limit to the intake rate of the processing section 432 of the decompressing section 430 because of its performance capabilities. In the present embodiment, the targeted compression ratio against which the CPU 310 functioning as the compression ratio determining section 313 in the DFE 300 checks the compression ratio of data is set to a value such that the intake rate of the processing section 432 does not exceed that upper limit to the intake rate of the processing section 432, that is, it is set to a value smaller than or equal to that upper limit rate divided by the output rate of the printer output section 450. Because the compression ratio of the compressed data sent from the DFE 300 meets this targeted compression ratio, which is a high value as mentioned above, the processing section 432 can take in and decompress the compressed data at a rate well within the upper limit and provides the decompressed bitmap data to the line buffer 440 at the required rate.

Two examples of operation in the data transfer system 30 according to the present invention described above will be considered. In one of the examples, the compression ratio of all blocks in one page of compressed data is as high as 1/10; in the other example, one page of compression data includes a block with a low compression ratio of ½. It is assumed here that the processing rate of the printer 20 is 300 Mbytes/s, the upper limit to the intake rate of the processing section 432 of the decompressing section 430 is 100 Mbytes/s, and the upper limit to the receiving rate of the receiving section 410 is 80 Mbytes/s.

It is also assumed in these examples that the targeted compression ratio is set to ⅓, which is the maximum intake rate (100 Mbytes/s) divided by the output rate (300 Mbytes/s) of the printer output section 450 which is equal to the processing rate of the printer 20, in order to allow the printer output section 450 to provide bitmap data to the printer 20 at a rate commensurate with the processing rate of the printer 20.

When the compression ratio of all blocks in one page of compressed data is as high as 1/10, the page of compressed data is sent to the BEP 400 because the compression ratios of all blocks of the page of data more than satisfy the targeted compression ratio (⅓). Because the processing section 432 provides decompressed bitmap data to the line buffer 440 at the same rate as the output rate (300 Mbytes/s), the intake rate of the processing section 432 is the output rate multiplied by the compression ratio ( 1/10), i.e. 30 Mbytes/s. The receiving rate of the receiving section 410 is equal to the intake rate, 30 Mbytes/s. Therefore, the processing section 432 and receiving section 410 perform processing at a rate well within the upper limit rates. Thus, the printer output section 450 can keep providing bitmap data to the printer 20 at an output rate of 300 Mbytes/s, which is equal to the processing rate of the printer 20.

On the other hand, when one page of compressed data includes a block with a low compression ratio of ½, the DFE 300 sends uncompressed bitmap data to the BEP 400 because the compression ratio of the block does not reach the targeted compression ratio (⅓). Then, the diverting section 431 in the BEP 400 provides the uncompressed bitmap data to the line buffer 440 at a rate of 300 Mbytes/s, which is equal to the processing rate of the printer 20. In this way, even if a block with a compression ratio as low as ½ is generated during generating one page of compression data in the DFE 300, the printer output section 450 can keep providing bitmap data to the printer 20 at an output rate of 300 Mbytes/s, which is equal to the processing rate of the printer 20, while the printer 20 is outputting one page of data.

As has been described, in the data transfer system 30 according to the present embodiment, the DFE 300 compresses each page of bitmap data block by block. When the data is decompressed in the BEP 400 and transferred to the destination, namely the printer 20, the page of compressed data is transferred only if the compression ratio of the all blocks in the page reaches the targeted compression ratio. Otherwise, uncompressed bitmap data is transferred. Thus, data compressed with a low compression ratio that could be an obstacle in transfer to the printer 20 is diverted around decompression and thereby the data is transferred without delay. Furthermore, in the data transfer system 30 according to the present embodiment, the compression ratio of each individual block is checked. Thus, if bitmap data to be compressed includes a data portion compressed to a low degree, the low degree of compression of the data portion is identified without fail. Moreover, the data transfer system 30 according to the present embodiment does not require expensive components that increase manufacturing costs, such as a high-performance decompressor capable of fast compression, therefore increases in manufacturing costs is suppressed.

In the foregoing description, the DFE 300 performs compression block by block, each block being an array of 8 rows of pixels as described above, and determines whether the compression ratio of each block meets a predetermined compression ratio and makes a selection based on the result of the determination as to whether the compressed data or uncompressed bit map data should be transferred. However, the present invention is not so limited. The data compressing apparatus of the present invention may perform the compression in units other than blocks. For example, an amount of data equal to the capacity of the line buffer 440 of the BEP 400 may be used as unit data. Furthermore, the data compressing apparatus may make the determination described above in units other than blocks. Also, the data compressing apparatus of the present invention may perform the selection in units of several pages or in units smaller than a page, such as on a per-half-page basis or on a per block basis.

The CPU 310 functioning as the compressing section 312 that applies compression to one page of bitmap data block by block, each block being an array of 8 rows of pixels, is given in the foregoing description as an example of the data compressing section. However, the present invention is not limited to this. The data compression section of the present invention may be a dedicated circuit which performs such compression.

While the output section 330 outputs compressed data and bitmap data in conformity of SCSI is given as an example of the data output section of the present invention, the present invention is not limited to this. The output section may be an element that outputs data in conformity to a non-SCSI communication standard. In that case, the receiving section in the present invention is a receiving section that receives compressed data and bitmap data in conformity to the non-SCSI communication standard.

What is claimed is:

1. A data transfer system comprising:
a data compressing apparatus; and
a data decompressing apparatus, the data compressing apparatus comprising:
a data compressing section which applies compression to uncompressed electronic data to obtain compressed electronic data; and
a data output section, which, if the compression achieves predetermined targeted compression, outputs compressed electronic data obtained by the data compressing section, and if the compression does not achieve the targeted compression, outputs uncompressed electronic data which is not subjected to the compression,
the data decompressing apparatus comprising:
a data receiving section which receives electronic data from the data compressing apparatus; and
a transferring section which, if the electronic data received at the receiving section is compressed electronic data, decompresses the electronic data and transfers the decompressed data to a predetermined destination, and if the electronic data received at the receiving section is uncompressed electronic data, transfers the electronic data to the destination as is.

2. The data transfer system according to claim 1, wherein the data compressing section sequentially applies the compression to each piece of a set of uncompressed electronic data; and
the data output section sequentially checks the result of compression applied by the data compression section and, if the targeted compression is achieved, outputs the compressed electronic data obtained from the set of the uncompressed electronic data in the data compression section, and if a result that does not achieve the targeted compression is provided, causes the data compression section to stop decompression and outputs the set of uncompressed electronic data.
